(19) United States
(12) Patent Application Publication
(10) Pub. No.: US 2011/0031730 A1
(43) Pub. Date: Feb. 10, 2011

(54) BOOK COVER WITH LOWER MATERIAL REQUIREMENTS AND IMPROVED STRESS DISTRIBUTION

(76) Inventor: Robert S. Silverman, Long Beach, CA (US)

Correspondence Address: Novel IP, 14252 CULVER DR. BOX 914, IRVINE, CA, 92604, US

(21) Appl. No.: 12/814,390

(22) Filed: Jun. 11, 2010

Related U.S. Application Data
(63) Continuation of application No. 12/567,685, filed on Sep. 25, 2009.
Application No. 12/567,685 is a continuation-in-part of application No. 11/861,373, filed on Sep. 26, 2007, now Pat. No. 7,758,077.
Application No. 11/861,373 is a continuation of application No. 11/157,006, filed on Jun. 20, 2005, now Pat. No. 7,290,801.
Application No. 11/157,006 is a continuation-in-part of application No. 10/177,964, filed on Jun. 24, 2002, now abandoned.
Application No. 10/177,964 is a continuation-in-part of application No. 12/630,041, filed on Dec. 3, 2009, now abandoned.
Application No. 12/630,041 is a continuation of application No. 10/974,988, filed on Oct. 28, 2004, now Pat. No. 7,648,173.
Application No. 10/974,988 is a continuation-in-part of application No. 11/964,901, filed on Dec. 27, 2007, now abandoned.
Application No. 11/964,901 is a continuation of application No. 11/224,505, filed on Sep. 13, 2005, now Pat. No. 7,334,819.
Application No. 11/224,505 is a continuation-in-part of application No. 12/335,630, filed on Dec. 16, 2008, now Pat. No. 7,753,411.
Application No. 12/335,630 is a continuation of application No. 10/534,448, filed on May 10, 2005, now Pat. No. 7,478,837.
(60) Provisional application No. 61/100,101, filed on Sep. 25, 2008.
(60) Provisional application No. 61/165,381, filed on Mar. 31, 2009.

(51) Int. Cl. B42D 3/02; B23P 17/04

(52) U.S. Cl. 281/35; 29/428

(57) ABSTRACT

The present invention is a book cover and a method of manufacturing thereof that requires less fabric than conventional covers and uses seaming/fastening on the inside of the cover in a manner that allows for better stress distribution. The stretchable book cover is formed from a pliable material and has an outer panel portion for covering a front cover, a back cover, and a spine portion of a book; four folded-in edge panel portions, which include a first side edge panel, a second side edge panel, a top edge panel, and a bottom edge panel; and at least one fabric strap for connecting the top edge panel to said bottom edge panel, forming a pair of apertures, permitting insertion of the front and back covers of the book into the cover such that the book cover does not have any seams coincident with any of edges of the book.

### CROSS-REFERENCE TO RELATED APPLICATIONS

The present invention is also a continuation of U.S. patent application Ser. No. 12/567,685, filed on Sep. 25, 2009, which relies on U.S. Provisional Patent Application No. 61/100,101, which was filed on Sep. 25, 2008 and U.S. Provisional Patent Application No. 61/165,381, which was filed on Mar. 31, 2009.

The present invention is also a continuation-in-part of U.S. patent application Ser. No. 11/861,373, entitled “Stretchable Fabric Book Cover and Method”, and filed on Sep. 26, 2007, which is a continuation of U.S. Pat. No. 7,290,801, of the same title, which issued on Nov. 6, 2007 and is a continuation-in-part of U.S. patent application Ser. No. 10/177,964, filed on Jun. 24, 2002 and abandoned.

The present invention is also a continuation-in-part of U.S. patent application Ser. No. 12/630,041, which was filed on Dec. 3, 2009 and which is a continuation of U.S. patent application Ser. No. 10/974,988, which has issued as U.S. Pat. No. 7,648,173 on Jan. 19, 2010.

The present invention is also a continuation-in-part of U.S. patent application Ser. No. 11/964,901, which was filed on Dec. 27, 2007 and which is a continuation of U.S. patent application Ser. No. 11/224,505, which has issued as U.S. Pat. No. 7,334,819 on Feb. 26, 2008.

Finally, the present invention is also a continuation-in-part of U.S. patent application Ser. No. 12/335,630, which was filed on Dec. 16, 2008 and which is a continuation of U.S. patent application Ser. No. 10/534,448, which has issued as U.S. Pat. No. 7,478,837 on Jan. 20, 2009 and which relies on U.S. Provisional Application No. 60/425,671 filed on Nov. 11, 2002 for priority.

All of the above listed applications and patents are incorporated herein by reference in their entirety.

### FIELD OF THE INVENTION

The present invention generally relates to the field of book covers, and more specifically to a book cover and a method of manufacturing thereof where the book cover requires less fabric than conventional covers and uses seaming/fastening on the inside of the cover in a manner that allows for better stress distribution.

### BACKGROUND OF THE INVENTION

Numerous book covers have been devised to protect schoolbooks and other hard covered texts from moisture or grime. Many of these coverings utilize paper wrappings or are fabricated from more durable plastic materials. Book cover applications typically require the time consuming steps of trimming the covering to size, fashioning and folding flaps, and then inserting the front and back panels of a bound book into lateral envelopes formed by the flaps. Adhesive tape may also be required to secure the protective covering into position, which will often mar a text when removed. Some conventional plastic book covers are similarly available with a coating of repositionable pressure sensitive adhesive. Although intended to removably cling to the exposed surfaces of a book, such coverings are known to become troublesome to remove after long term usage.

Alternatively, stretchable fabric covers have attempted to remedy the problems of paper and plastic sleeves in protecting the vulnerable surfaces of a book. However, these fabric covers tend to be costlier than their paper and plastic counterparts. Also, since the edges of the insides of these fabric covers are seamed/fastened these seams tend to be vulnerable to stress that is typically high at the edges leading to tearage.

Accordingly, there is need for a book cover that is made out of stretchable fabric but uses the fabric economically to reduce overall cost of manufacturing of the cover without compromising on the sturdiness of the cover. There is also need in the art for a book cover that uses seams/fastening at the inside of the cover such that these are substantially away from the high stress prone edges of the cover thereby improving the durability of the cover.

### SUMMARY OF THE INVENTION

The present invention is, in one embodiment, a stretchable book cover for insertion of a book therein, said cover comprising: an outer panel portion for covering a front cover, a back cover, and a spine portion of said book, each of said front cover, back cover, and spine having edges; four folded-in edge panel portions, wherein said four folded-in edge panel portions include a first side edge panel, a second side edge panel, a top edge panel, and a bottom edge panel; said four folded-in edge panel portions form the interior panel portion of said book cover; an edge of said first side edge panel is attached to an edge of said top edge panel to form an angled seam; an edge of said second side edge panel is attached to an edge of said top edge panel to form an angled seam; an edge of said first side edge panel is attached to an edge of said bottom edge panel to form an angled seam; an edge of said second side edge panel is attached to an edge of said bottom edge panel to form an angled seam; and no seam is formed directly between said top edge panel and said bottom edge panel; at least one fabric strap for connecting said top edge panel to said bottom edge panel, forming a pair of apertures, extending substantially parallel with said book spine, to permit insertion of said front and back covers of said book into the cover, wherein said cover is comprised of a pliable material and wherein said book cover does not have any seams coincident with any of said edges of said book.

In one embodiment, said edge panels are joined in mutual secured relation by connecting means selected from the group consisting of stitching, taping, gluing, ultrasonic welding, RF welding, and heat sealing. In one embodiment, a SPANDEX yarn is employed for seam stitching. Preferably, said seams are stretchable, allowing for varying seam width and length and greater flexibility of the seam.

In another embodiment, the present invention is a stretchable book cover for insertion of a book therein, said cover comprising: an outer panel portion for covering a front cover, a back cover, and a spine portion of said book, each of said front cover, back cover, and spine having edges; four folded-in edge panel portions, wherein said four folded-in edge panel portions include a first side edge panel, a second side edge panel, a top edge panel, and a bottom edge panel; at least one fabric strap for connecting said top edge panel to said bottom edge panel, forming a pair of apertures, extending substantially parallel with said book spine, to permit insertion of said front and back covers of said book into the cover, wherein said cover is comprised of a pliable material and wherein said book cover does not have any seams coincident with any of said edges of said book.

In one embodiment, the four folded-in edge panel portions form the interior panel portion of said book cover. In one embodiment, an edge of said first side edge panel is attached to an edge of said top edge panel to form an angled seam; an edge of said second side edge panel is attached to an edge of said top edge panel to form an angled seam; an edge of said first side edge panel is attached to an edge of said bottom edge panel to form an angled seam; an edge of said second side edge panel is attached to an edge of said bottom edge panel to form an angled seam; and no seam is formed directly between said top edge panel and said bottom edge panel. In one embodiment, the edge panels are joined in mutual secured relation by attaching means selected from the group consisting of stitching, taping, gluing, ultrasonic welding, RF welding, and heat sealing. In one embodiment, a SPANDEX yarn is employed for seam stitching. In one embodiment, the seams are stretchable, allowing for varying seam width and length and greater flexibility of the seam.

In one embodiment, the pliable material employed is a fabric comprised of elastic and stretchable threads. In addition, the at least one fabric strap is comprised of a stretchable material, such as elastic.

In one embodiment, the present invention is a method of manufacturing a book cover from a sheet of pliant material comprising the steps of: cutting a laterally-elongated, unequal hexagon from a sheet of material; creating a top fold line, a bottom fold line, and side fold lines to form rectangular outer bounds of said cover; forming at least one top edge panel by folding the material over at a top fold line; forming at least one bottom edge panel by folding the material over at a bottom fold line; forming a first side edge panel and a second side edge panel by folding the material over at a first side fold line and a second side fold line, respectively; adjoining edge panel portions; and fastening a first fabric strap and a second fabric strap to each of said top and bottom edge panels to connect and hold together said top and bottom edge panels for insertion of book covers flaps therein.

In one embodiment, the step of adjoining edge panel portions includes attaching an edge of a first side edge panel to an edge of said top edge panel to form an angled seam; attaching an edge of a second side edge panel to an edge of said top edge panel to form an angled seam; attaching an edge of said first side edge panel to an edge of said bottom edge panel to form an angled seam; and attaching an edge of said second side edge panel to an edge of said bottom edge panel to form an angled seam.

### BRIEF DESCRIPTION OF THE DRAWINGS

These and other features and advantages of the present invention will be appreciated, as they become better understood by reference to the following detailed description when considered in connection with the accompanying drawings, wherein:

FIG. 1a is an illustration of one embodiment of the book cover of the present invention, while the book cover is laid open and covering book flaps;

FIG. 1b is an illustration of another embodiment of the book cover of the present invention, while the book cover is laid open and covering book flaps;

FIG. 1c is an interior planar view of the book cover of the present invention in open configuration;

FIG. 2 is a planar, unfolded view of the book cover of the present invention, which, in one embodiment, is an unequal octagonal cover blank that is used to manufacture the book cover; and

FIG. 3 is a flow diagram describing exemplary manufacturing steps of the book cover in accordance with the principles of the present invention.

### DETAILED DESCRIPTION OF THE INVENTION

The present invention is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

U.S. Pat. No. 7,290,801, entitled “Stretchable Fabric Book Cover and Method”, assigned to the assignee of the present invention and issued on Nov. 6, 2007, is herein incorporated by reference in its entirety.

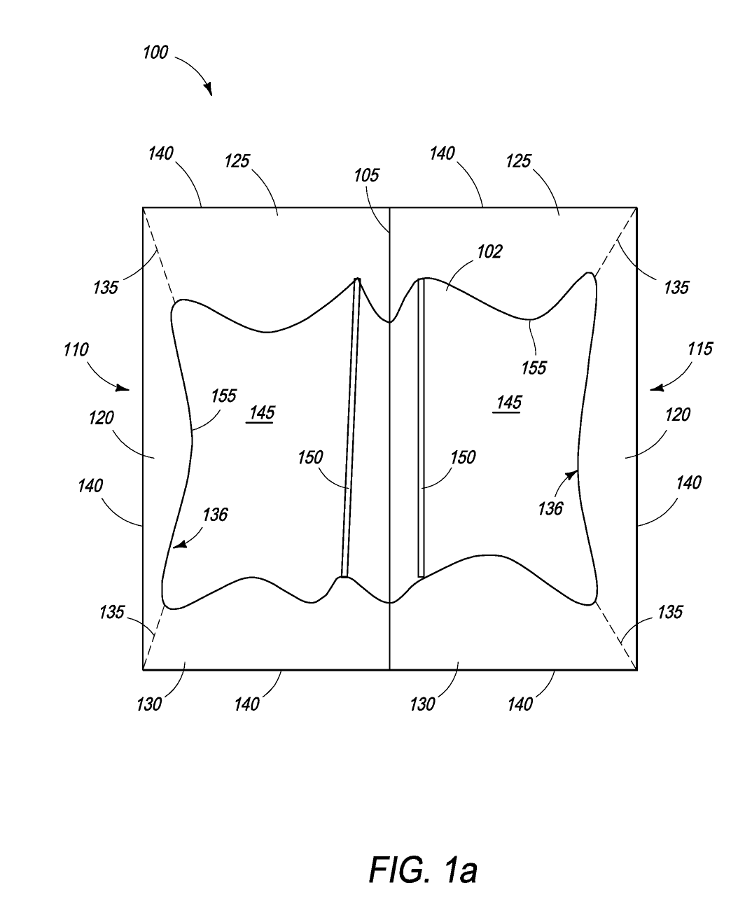

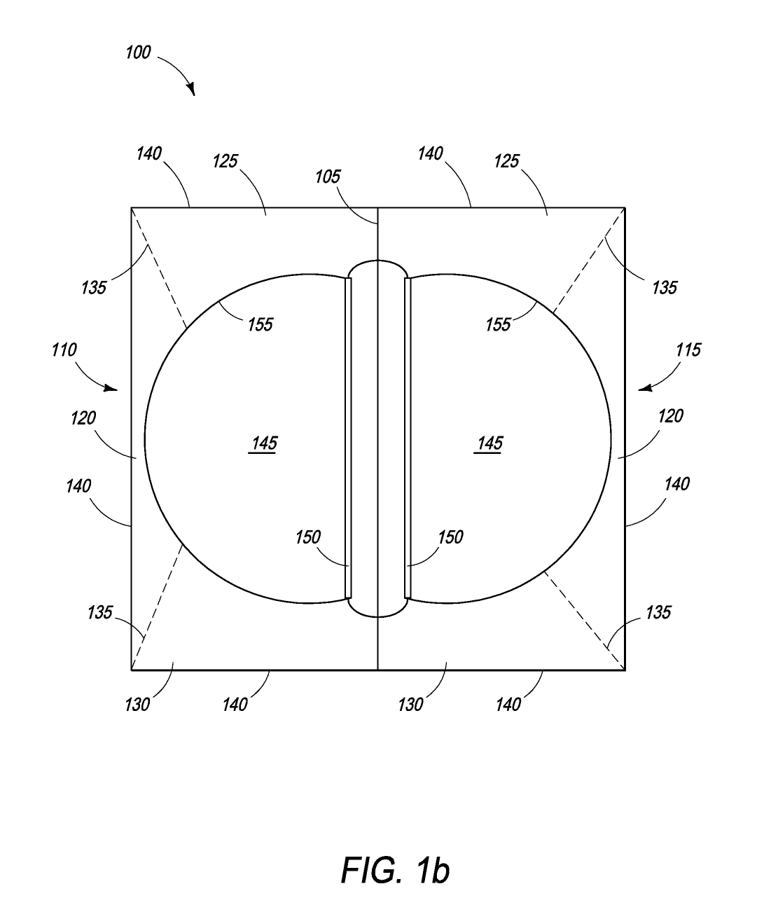

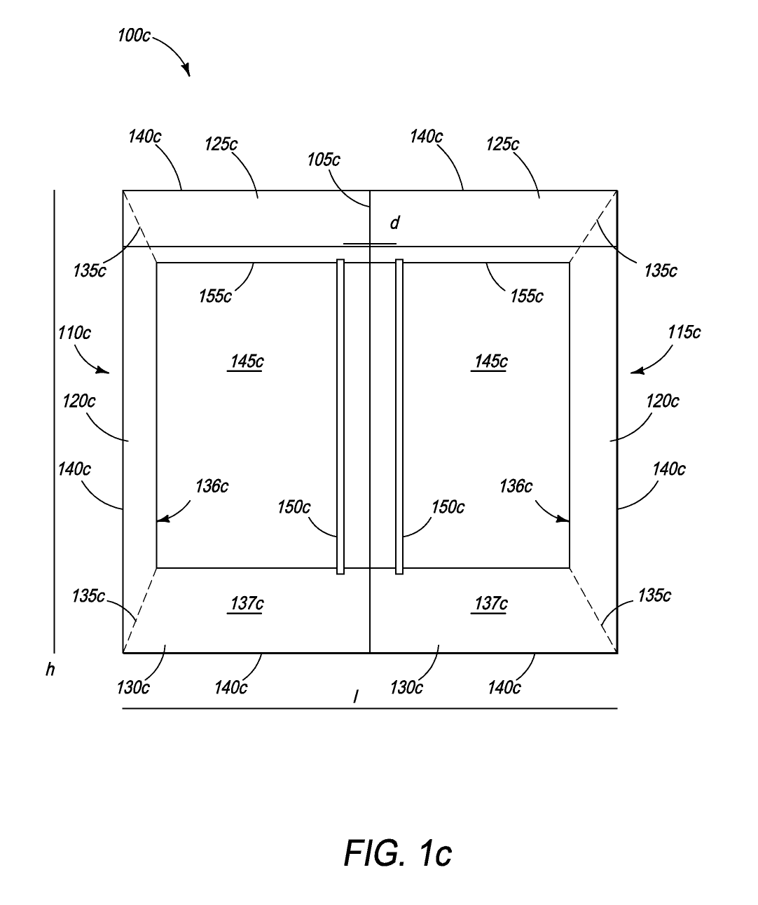

FIGS. 1a and 1b show embodiments of the book cover 100 of the present invention that are used to contain and conceal a book 102 (internal pages not shown), which has a front cover flap and a back cover flap (partially concealed by book cover of present invention). As shown FIG. 1a, book cover 100 comprises outer panel portions extending from a spine cover portion 105 that is laterally bounded by a left front cover portion 110, for the book front cover, and a right rear cover portion 115 to receive the book back cover. The cover 100 consists of a plurality of panels in a folded-in edge secured relationship.

As shown in FIGS. 1a and 1b, the cover 100 has side edge panel portions 120, top edge panels 125 and bottom edge panels 130, that form a portion of the interior of the book cover 100. The side edge panels 120 interface with the top and bottom edge panels 125, 130 at seams 135 that are connected by rows of stitching, thereby forming apertures or pockets 136 for receiving a book front cover and book back cover. It should be noted herein, and is described in greater detail below, that apertures or pockets 136 do not completely cover the inner surfaces 137 of the book front cover or book back cover. In one embodiment, a SPANDEX yarn is employed for seam stitching. The use of a stretchable, SPANDEX yarn allows for varying seam width and length, and greater flexibility of the seam, also dependent on choice of fabric. It would be evident to persons of ordinary skill in the art that alternative forms of connection such as taping and/or gluing, metal fasteners, ultrasonic welding or RF welding, or heat sealing can also be utilized.

In one of the advantages of the book cover 100, the seams 135 are not along the edges 140 of the cover 100. This is an intentional departure from prior art covers where conventionally the seams are along the edges 140. Persons of ordinary skill in the art would appreciate that the edges 140 tend to receive the greatest stress. In the cover 100 of the present invention, the seams 135 that are the weakest part of the cover, are formed away from the edges 140 which receive the greatest stress. The seams 135, by being formed approximately diagonally and therefore away from the edges 140 of the cover 100 enable stress distribution that promotes durability of the cover 100.

Referring back to FIGS. 1a and 1b, and as mentioned above, the top edge panels 125 do not interface with the bottom edge panels 130, thereby eliminating cover fabric in the middle portion 145 and not completely covering the inner portions of the book front cover and book back cover. Instead, fabric straps 150 are used to connect the top and bottom panels 125, 130 providing additional sturdiness and support to keep the panels 125, 130 in a stable relationship with each other and help retain the cover 100 on the book. By eliminating excess fabric that would have otherwise been used in the middle portion 145 and using fabric straps 150 instead, the cover 100 of the present invention promotes an eco-friendly structure that enables lower cost of manufacturing of the cover 100 and lower amounts of residual waste. Accordingly, in at least one embodiment of the present invention, the book cover has angled seams in the interior of the book cover, does not have the top and bottom panels of the front book cover or back book cover connect, and has primarily empty space in the middle of the interior of the front book cover and back book cover, or, stated differently, is devoid of material in the middle of the interior of the front book cover and back book cover.

In one embodiment, the inside edges 155 of the side, top and bottom panels 120, 125 and 130, respectively, and thus, the apertures or pockets 136 are curvilinear or wavy providing aesthetic sense to the inside of the cover 100, as shown in FIG. 1a. In another embodiment, the inside edges 155 of the side, top and bottom panels 120, 125 and 130 respectively, and thus, the apertures or pockets 136, are concaved, as shown in FIG. 1b. Thus, as shown in FIG. 1b, the middle portion 145 is oval or elliptical in shape. In alternate embodiments, these edges 155 are straight, slanted or of any other contour as would be evident to persons of ordinary skill in the art and the middle portion 145 and apertures or pockets 136 take on the shape as defined by edges 155.

FIG. 1c is an interior planar view of the book cover of the present invention in open configuration. The book cover 100c comprises outer panel portions extending from a spine cover portion 105c that is laterally bounded by a left front cover portion 110c, for the book front cover, and a right rear cover portion 115c to receive the book back cover. The cover 100c consists of a plurality of panels in a folded-in edge secured relationship.

The cover 100c has side edge panel portions 120c, top edge panels 125c and bottom edge panels 130c, that form a portion of the interior of the book cover 100c. Side edge panels 120c interface with the top and bottom edge panels 125c, 130c at seams 135c that are connected by rows of stitching, thereby forming apertures or pockets 136c for receiving a book front cover and book back cover. It should be noted herein, and is described in greater detail below, that apertures or pockets 136c do not completely cover the inner surfaces 137c of the book front cover or book back cover. It would be evident to persons of ordinary skill in the art that alternative forms of connection such as taping and/or gluing, metal fasteners, ultrasonic welding or R.F welding, or heat sealing can also be utilized.

In one of the advantages of the book cover 100c, the seams 135c are not positioned along the edges 140c of the cover 100c. This is an intentional departure from prior art covers where conventionally the seams are along the edges 140c. Persons of ordinary skill in the art would appreciate that the edges 140c tend to receive the greatest stress. In the cover 100c of the present invention, the seams 135c that are the weakest part of the cover, are formed away from the edges 140c which receive the greatest stress. The seams 135c, by being formed approximately diagonally and therefore away from the edges 140c of the cover 100c enable stress distribution that promotes enhanced durability of the cover 100c.

The top edge panels 125c do not interface with the bottom edge panels 130c, thereby eliminating cover fabric in the middle portion 145c. Conventional book covers ten to include fabric that covers the inner flap portion 137c of a book. This obstructs the view of the inside flap portion of the book, which may be necessary to view (i.e. marking names, library issuance, etc.). Instead, the present invention employs fabric straps 150c to connect the top and bottom panels 125c, 130c providing additional sturdiness and support to keep the panels 125c, 130c in a stable relationship with each other and help retain the cover 100c on the book. By eliminating excess fabric that would have otherwise been used in the middle portion 145c and using fabric straps 150c instead, the cover 100c of the present invention promotes an eco-friendly structure that enables lower cost of manufacturing of the cover 100c and lower amounts of residual waste. Thus, the present invention uses substantially less fabric than conventional stretchable book covers.

In one embodiment, the fabric straps are comprised of a non-stretchable material, such as, but not limited to, nylon fishing line. In another embodiment, the fabric straps are comprised of a stretchable material, such as, but not limited to, elastic or elastic thread. The length and width of the fabric straps are selected and designed considering the fabric chosen for the book cover. Thus, the fabric straps can be shaped and sized in any fashion to achieve the objectives of the present invention. In one embodiment, the fabric straps are attached to the book cover via a lockstitch.

In one embodiment, the inside edges 155c of the side, top and bottom panels 120c, 125c and 130c respectively are substantially straight. In one embodiment, the book cover 100c has dimensions of 7.75 inches (h) and 14.5 inches (l) and a spaced, d, between the straps 150c of 2.5 inches. In another embodiment, the book cover 100c has dimensions in the range of 4 to 11 inches (including approximately 5, 6, 7, 8, 9, and 10 inches) (h) and 8 to 20 inches (including approximately 9, 10, 11, 12, 13, 14, 15, 16, 17, 18, and 19 inches) (l) and a spaced, d, between the straps 150c of 1 to 4 inches (including approximately 2 and 3 inches). This book cover can be used to cover a standard book, which has a height of 11 inches, width of 9.5 inches, and spine area of 1.75 inches, and a jumbo book, which has a height of 10.25 inches, width of 8 inches, and spine area of 1.25 inches. It should be noted that the book cover can have varying dimensions, dependent upon the material chosen, and can be manufactured to achieve the objectives of the present invention.

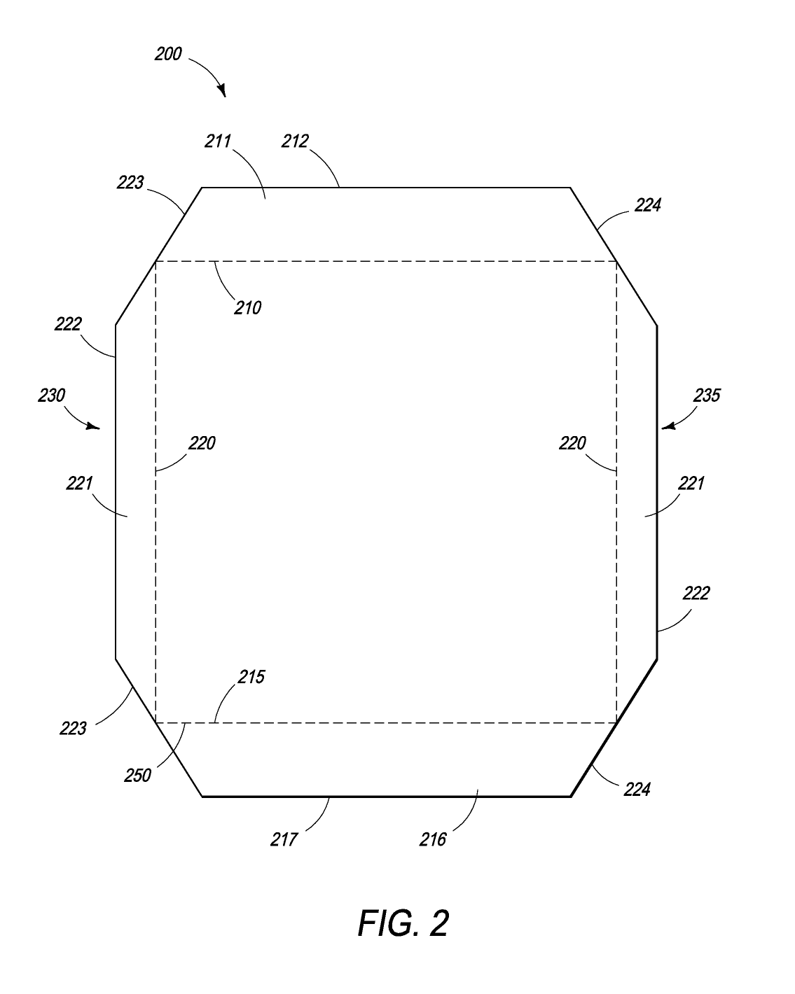

FIG. 2 is a planar, unfolded view of the book cover of the present invention, which, in one embodiment, is an unequal octagonal cover blank 200 that is used to manufacture the book cover as shown in FIGS. 1a, 1b, and 1c. The cover blank 200 is an unequal octagon and may be cut from SPANDEX™ material, or other fabric materials composed of stretchable elastic threads, such as nylon. A top fold line 210 and a bottom fold line 215, along with side fold lines 220, form the bounds of the cover outer panel 250, which comprises the intermediate spine area. The intermediate spine area allows for a book with any size spine to be easily covered. The fold lines 210, 215 and 220 define one side of each of the top, bottom and side panels 211, 216 and 221 respectively. The width of each of the panels 211, 216 and 221 is such that when folded along the respective fold-lines they leave a middle portion uncovered. A pair of fabric straps (not shown) is used to transversely connect the top and bottom panel portions in folded state. Again, it should be noted that the book cover can have varying dimensions, dependent upon the material chosen, and can be manufactured to achieve the objectives of the present invention. Thus, the dimensions of the book cover are dependent upon the stretchability of the material chosen for the book cover of the present invention. Thus, in one embodiment, if a particularly stretchable material is chosen, the book cover may be smaller than if a less stretchable material is chosen, so long at it achieves the objectives of the present invention. Thus, the dimensions of the book cover can be modified to accommodate any size book, keeping in mind the stretching or elastic properties of the material chosen.

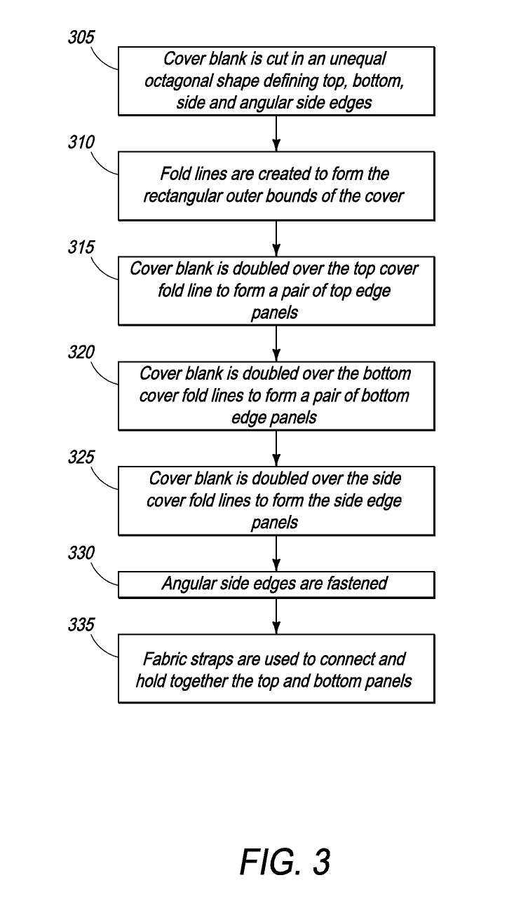

FIG. 3 is a flow diagram describing a method of manufacturing the book cover of the present invention. Referring now to various elements of the cover blank 200 of FIG. 2 and the flow diagram steps of FIG. 3 simultaneously, at step 305 the cover blank 200 is cut in an unequal octagonal shape defining top, bottom and side edges 212, 217 and 222. Angular side edges 223 are in parallel relationship with angular side edges 224. At step 310, top, bottom, and side fold lines 210, 215 and 220, respectively, are created to form the rectangular outer bounds of the cover. At step 315, the cover blank 200 is doubled over the top cover fold line 210 to form a pair of top edge panels 211. Similarly, at step 320, the cover blank 200 is doubled over the bottom cover fold lines 215 to form a pair of bottom edge panels 216. Again, at step 325, the cover blank 200 is doubled over the side cover fold lines 220 to form the side edge panels 221. At step 330, the angular side edges 223 and 224 are fastened by rows of stitching or alternatively taping, gluing, ultrasonic/R.F welding, or heat sealing. Finally, at step 335 a first and a second fabric strap are used to connect and hold together, in fastened relationship, the top and bottom panels 211 and 216 of the front and rear cover portions 230, 235.

1. A stretchable book cover for insertion of a book therein, said cover comprising:
a. an outer panel portion for covering a front cover, a back cover, and a spine portion of said book, each of said front cover, back cover, and spine having edges;
b. four folded-in edge panel portions, wherein
i. said four folded-in edge panel portions include a first side edge panel, a second side edge panel, a top edge panel, and a bottom edge panel;
ii. said four folded-in edge panel portions form the interior panel portion of said book cover;
iii. an edge of said first side edge panel is attached to an edge of said top edge panel to form an angled seam;
iv. an edge of said second side edge panel is attached to an edge of said top edge panel to form an angled seam;
v. an edge of said first side edge panel is attached to an edge of said bottom edge panel to form an angled seam;
vi. an edge of said second side edge panel is attached to an edge of said bottom edge panel to form an angled seam; and
vii. no seam is formed directly between said top edge panel and said bottom edge panel;
c. at least one fabric strap for connecting said top edge panel to said bottom edge panel, forming a pair of apertures, extending substantially parallel with said book spine, to permit insertion of said front and back covers of said book into the cover, wherein said cover is comprised of a pliable material and wherein said book cover does not have any seams coincident with any of said edges of said book.

2. The stretchable book cover of claim 1 wherein said edge panels are joined in mutual secured relation by connecting means selected from the group consisting of stitching, taping, gluing, ultrasonic welding, RF welding, and heat sealing.

3. The stretchable book cover of claim 2 wherein a SPANDEX yarn is employed for seam stitching.

4. The stretchable book cover of claim 1 wherein said seams are stretchable, allowing for varying seam width and length and greater flexibility of the seam.

5. The stretchable book cover of claim 1 wherein said pliable material is a fabric comprised of elastic and stretchable threads.

6. The stretchable book cover of claim 1 wherein said at least one fabric strap is comprised of a stretchable material.

7. The stretchable book cover of claim 6 wherein said at least one fabric strap is comprised of elastic.

8. A stretchable book cover for insertion of a book therein, said cover comprising:
a. an outer panel portion for covering a front cover, a back cover, and a spine portion of said book, each of said front cover, back cover, and spine having edges;
b. four folded-in edge panel portions, wherein said four folded-in edge panel portions include a first side edge panel, a second side edge panel, a top edge panel, and a bottom edge panel;
c. at least one fabric strap for connecting said top edge panel to said bottom edge panel, forming a pair of apertures, extending substantially parallel with said book spine, to permit insertion of said front and back covers of said book into the cover, wherein said cover is comprised of a pliable material and wherein said book cover does not have any seams coincident with any of said edges of said book.

9. The stretchable book cover of claim 8 wherein said four folded-in edge panel portions form the interior panel portion of said book cover.

10. The stretchable book cover of claim 8 wherein an edge of said first side edge panel is attached to an edge of said top edge panel to form an angled seam; an edge of said second side edge panel is attached to an edge of said top edge panel to form an angled seam; an edge of said first side edge panel is attached to an edge of said bottom edge panel to form an angled seam; an edge of said second side edge panel is attached to an edge of said bottom edge panel to form an angled seam; and no seam is formed directly between said top edge panel and said bottom edge panel.

11. The stretchable book cover of claim 1 wherein said edge panels are joined in mutual secured relation by attaching means selected from the group consisting of stitching, taping, gluing, ultrasonic welding, RF welding, and heat sealing.

12. The stretchable book cover of claim 11 wherein a SPANDEX yarn is employed for seam stitching.

13. The stretchable book cover of claim 8 wherein said seams are stretchable, allowing for varying seam width and length and greater flexibility of the seam.

14. The stretchable book cover of claim 8 wherein said pliable material is a fabric comprised of elastic and stretchable threads.

15. The stretchable book cover of claim 8 wherein said at least one fabric strap is comprised of a stretchable material.

16. The stretchable book cover of claim 15 wherein said at least one fabric strap is comprised of elastic.

17. A method of manufacturing a book cover from a sheet of pliant material comprising the steps of: cutting a laterally-elongated, unequal hexagon from a sheet of material; creating a top fold line, a bottom fold line, and side fold lines to form rectangular outer bounds of said cover; forming at least one top edge panel by folding the material over at a top fold line; forming at least one bottom edge panel by folding the material over at a bottom fold line; forming a first side edge panel and a second side edge panel by folding the material over at a first side fold line and a second side fold line, respectively; adjoining edge panel portions; and fastening a first fabric strap and a second fabric strap to each of said top and bottom edge panels to connect and hold together said top and bottom edge panels for insertion of book covers flaps therein.

18. The method of manufacturing a book cover of claim 17, wherein said step of adjoining edge panel portions includes attaching an edge of a first side edge panel to an edge of said top edge panel to form an angled seam; attaching an edge of a second side edge panel to an edge of said top edge panel to form an angled seam; attaching an edge of said first side edge panel to an edge of said bottom edge panel to form an angled seam; and attaching an edge of said second side edge panel to an edge of said bottom edge panel to form an angled seam.

19. The stretchable book cover of claim 18 wherein said edge panels are joined in mutual secured relation by attaching means selected from the group consisting of stitching, taping, gluing, ultrasonic welding, RF welding, and heat sealing.

20. The stretchable book cover of claim 17 wherein said pliant material is a fabric comprised of elastic and stretchable threads.
